(19) United States
(12) Patent Application Publication
(10) Pub. No.: US 2023/0293915 A1
(43) Pub. Date: Sep. 21, 2023

(54) ELECTRIC BREATHING APPARATUS AND AIR FILTER DEVICE THEREFOR

(71) Applicant: TECMEN ELECTRONICS CO., LTD, Nanjing, Jiangsu (CN)

(72) Inventor: Ziqian WU, Nanjing, Jiangsu (CN)

(21) Appl. No.: 18/006,550

(22) PCT Filed: Jul. 19, 2021
(86) PCT No.: PCT/CN2021/107077

§ 371 Date: Jan. 23, 2023

(30) Foreign Application Priority Data
Jul. 21, 2020 (CN) 202010704664.1
Jul. 21, 2020 (CN) 202021443693.9

(51) Int. Cl. A62B 7/10; A62B 9/04

(52) U.S. Cl. CPC A62B 7/10; A62B 9/04

(57) ABSTRACT

The present application discloses an electric breathing apparatus and an air filter device for the same. The air filter device comprises a blower unit including a housing; and an air filter unit removably connectable to the blower unit. The housing includes an interface configured to face towards the air filter unit when the blower unit and the air filter unit are connected to each other. A casing of the air filter unit includes a filter mesh side configured to face towards the blower unit when the blower unit and the air filter unit are connected to each other. The housing of the blower unit includes a first subset of Hall sensors at the interface. The first subset of Hall sensors includes N Hall sensors spaced from each other, wherein the N is an integer equal to or greater than 2. The casing of the air filter unit includes N alignment positions at the filter mesh side. When the air filter unit is connected to the housing of the blower unit, the N alignment positions are aligned with the N Hall sensors respectively. The air filter unit includes one or N magnetic counterparts selectively located at the N alignment positions. The one or N magnetic counterparts are arranged in a manner corresponding to an operating mode of the blower unit with respect to the air filter unit.

### CROSS REFERENCE TO RELATED APPLICATIONS

This application is a 371 National Stage of International Application No. PCT/CN2021/107077, filed Jul. 19, 2021, which claims priority to Chinese Patent Application No. 202010704664.1 filed on Jul. 21, 2020 and Chinese Patent Application No. 202021443693.9 filed on Jul. 21, 2020, the disclosures of which are herein incorporated by reference in their entirety.

### FIELD

The present application generally relates to an electric breathing apparatus, especially an air filter device for the electric breathing apparatus.

### BACKGROUND

An electric breathing apparatus, as a constituent part of a life environment support system, is widely used in various harmful situations so as to ensure that a user is able to safely and reliably breathe clean air at a site hazardous to a human body, such as a harsh welding work site or even an emergency medical diagnostic site where there is a risk of infection of respiratory disease.

The electric breathing apparatus generally comprises a blower unit capable of being worn on the waist of a user's body, a filter unit releasably installed onto the blower unit, a breaching mask (or alternatively a welding helmet for a welding application), as well as a connecting pipe between the filter unit and the breathing mask. Ambient air is driven by a part of the blower unit so as to be sucked into the blower unit and further supplied by the connecting pipe to the breathing mask for inhalation by the user.

The filter unit as a consumable has to be replaced by a new one after a period of usage. However, when the filter unit is installed to the blower unit rather than in place (i.e. the filter unit is not in a correct position relative to the blower unit although the former has been installed to the latter), air, which is not effectively filtered, may possibly be sucked into the blower unit for inhalation by the user via the connecting pipe, thus damaging the health of the user. At busy building or work sites, after the filter is installed to the blower unit, the user usually has no time to check whether the filter unit is installed thereto in place and/or whether the connecting pipe is installed in place. Therefore, such a case needs to be avoided. Otherwise, if the blower unit is rashly activated with the filter being not installed onto the blower unit in place and/or the connecting pipe being not installed onto the filter and/or the blower unit in place, the user will breathe harmful air and thus his/her health is damaged.

Furthermore, after being purchased, the electric breathing apparatus may be used by the user at various work sites. As the various work sites require that various filter units are equipped for the blower unit and the blower unit's operating mode has to be reset with respect to the various filter units, the user will have to manually adjust the blower unit's configuration. This puts forward a higher request to the user's operation proficiency, thus going against that the user, who is equipped with the electric breathing apparatus, quickly adapts to different work sites.

### SUMMARY

In order to solve the above issues, the present application is aimed at proposing an improved electric breathing apparatus such that the electric breathing apparatus can be activated only when constituent parts of the electric breathing apparatus are installed relative to each other in place, and that after different filter units are assembled onto a blower unit of the electric breathing apparatus, the blower unit's operating mode is automatically adjustable, bringing great convenience for a user.

According to one aspect of the present application, an air filter device for an electric breathing apparatus is proposed, the air filter device comprising: a blower unit configured to include a housing in which an electric blower is disposed; an air filter unit configured to be releasably connectable to the blower unit, the housing of the blower unit including an interface configured to face towards the air filter unit when the blower unit is connected to the air filter unit, the air filter unit including a casing, the casing including a filter mesh side configured to face towards the blower unit when the blower unit is connected to the air filter unit, wherein the housing of the blower unit also includes a first subset of Hall sensors in the interface, the first subset of Hall sensors comprises N Hall sensors spaced from each other, wherein N is an integer which is equal to or greater than 2; the casing of the air filter unit also includes N alignment positions configured to align with the N Hall sensors respectively when the air filter unit is connected to the housing of the blower unit; the casing of the air filter unit also includes 1˜N magnetic counterparts selectively disposed at the N alignment positions, and the 1˜N magnetic counterparts are configured to be arranged at the N alignment positions in a manner matching with an operating mode of the blower unit with respect to the air filter unit. In the context of the present application, the wording “1˜N” means that the number of relevant part(s) may be 1, 2, 3, . . . , or N.

Optionally, the 1˜N magnetic counterparts are configured to be selectively arranged at the N alignment positions in 2N−1 manners.

Optionally, the Hall sensors are disposed in the housing of the blower unit in such a way that they are invisible from the outside; and/or the 1˜N magnetic counterparts are disposed in the casing of the air filter unit in such a way that they are invisible from the outside.

Optionally, the housing of the blower unit also includes a second subset of Hall sensors in the interface, wherein the second subset of Hall sensors includes at least one Hall sensor; the casing of the air filter unit also includes at least one additional alignment position in the filter mesh side, which at least one additional alignment position is configured to be aligned with the second subset of Hall sensors respectively when the air filter unit is installed onto the blower unit in place; one additional magnetic counterpart is disposed at each of the at least one additional alignment position.

Optionally, the housing of the blower unit is configured to include a first annular edge formed around the interface, the casing of the air filter unit is configured to include a second annular edge formed around the filter mesh side, the first annular edge and the second annular edge are configured to be in complete contact with each other when the air filter unit is installed onto the blower unit in place.

Optionally, the first subset of and/or the second subset of Hall sensors is located in a region surrounded by the first annular edge; and/or the N alignment positions and/or the at least one additional alignment position is located in a region surrounded by the second annular edge.

Optionally, the air filter device also comprises a connector port configured to be releasably connectable to a joint of a connecting hose of the electric breathing apparatus, wherein the connector port is provided with a third subset of Hall sensors comprising at least one Hall sensor, the joint is configured to include at least one additional alignment position configured to be aligned with the third subset of Hall sensors respectively when the joint is installed to the connector port in place, and one additional magnetic counterpart is provided respectively at each of the at least one additional alignment position of the joint.

Optionally, the magnetic counterpart/counterparts comprise a magnetic ball or sheet made of a permanent magnet material.

According to another aspect of the present application, an air filter device for an electric breathing apparatus is proposed, the air filter device comprising: a blower unit configured to include a housing in which an electric blower is disposed; an air filter unit configured to be releasably connectable to the blower unit, the housing of the blower unit including an interface configured to face towards the air filter unit when the blower unit is connected to the air filter unit, the air filter unit including a casing, the casing including a filter mesh side configured to face towards the blower unit when the blower unit is connected to the air filter unit, wherein the housing of the blower unit also includes a first subset of proximity switches in the interface, the first subset of proximity switches comprises N proximity switches spaced from each other, wherein N is an integer which is equal to or greater than 2; the casing of the air filter unit also includes N alignment positions configured to align with the N proximity switches respectively when the air filter unit is connected to the housing of the blower unit; the air filter unit includes 1˜N counterparts selectively disposed at the N alignment positions, and the 1˜N counterparts are configured to be arranged at the N alignment positions in a manner matching with the operating mode of the blower unit with respect to the air filter unit.

According to another aspect of the present application, an electric breathing apparatus is proposed which comprises: the air filter device as mentioned; a breathing mask; and a connecting hose configured to be connected between the breathing mask and the air filter device.

According to another aspect of the present application, a method for operating the air filter device as mentioned is proposed, comprising: connecting an air filter unit of the air filter device to a blower unit; aligning N alignment positions of the air filter unit with N Hall sensors of a first subset of Hall sensors of the blower unit respectively, wherein the N is an integer which is equal to or greater than 2; detecting how many magnetic counterparts are presented at the N alignment positions and/or the layout of the magnetic counterpart or the magnetic counterparts arranged at the N alignment positions; comparing the detected result with pre-stored magnetic counterpart cases and/or layouts to determine a model/type of the air filter unit; and resetting an operating mode of the blower unit depending on the determined model/type of the air filter unit.

Optionally, after the air filter unit is connected to the blower unit and before the model/type of the air filter unit is determined, the second subset of Hall sensors of the blower unit is monitored to determine whether and/or the second subset of Hall sensors is aligned with the additional magnetic counterpart at the additional alignment position of the air filter unit so as to determine whether the air filter unit has been installed onto the blower unit in place.

Optionally, an alarm is sent out and/or the blower unit is deactivated if the air filter unit is not installed onto the blower unit in place.

Using the above technical measures of the present application, it can be checked whether the air filter unit is installed to the blower unit in place and whether the connecting pipe is connected to the air filter device in place, and the model of the air filter unit can be automatically identified out and thus the operating mode of the blower unit can be reset correspondingly. Therefore, the operational reliability and convenience of the electric breathing apparatus according to the present application can be improved.

### BRIEF DESCRIPTION OF THE DRAWINGS

The principles and various aspects of the present application can be more fully understood by the following detailed description in combination of the attached drawings. It should be noted that the drawings may be given in different ratios for clarity, which shall not be deemed to affect understanding to the present application. In the drawings:

FIG. 1 is a view schematically illustrating an electric breathing apparatus according to one embodiment of the present application.

FIG. 2 is a perspective view schematically illustrating a filter unit of the electric breathing apparatus according to one example of the present application.

FIG. 3 is a perspective view schematically illustrating a blower unit of the electric breathing apparatus according to one example of the present application.

FIG. 4 is a view schematically illustrating the blower unit of the electric breathing apparatus according to the example of the present application, wherein the blower unit is to be coupled to a joint of a connecting pipe.

FIG. 5 is a view schematically illustrating a combination manner of magnetic counterparts according to one example of the present application.

FIG. 6 is a flow chart schematically illustrating a control operation method according to one example of the present application.

### DETAILED DESCRIPTION

In the drawings of the present application, those features having the same configuration or a similar function are represented by the same reference numerals.

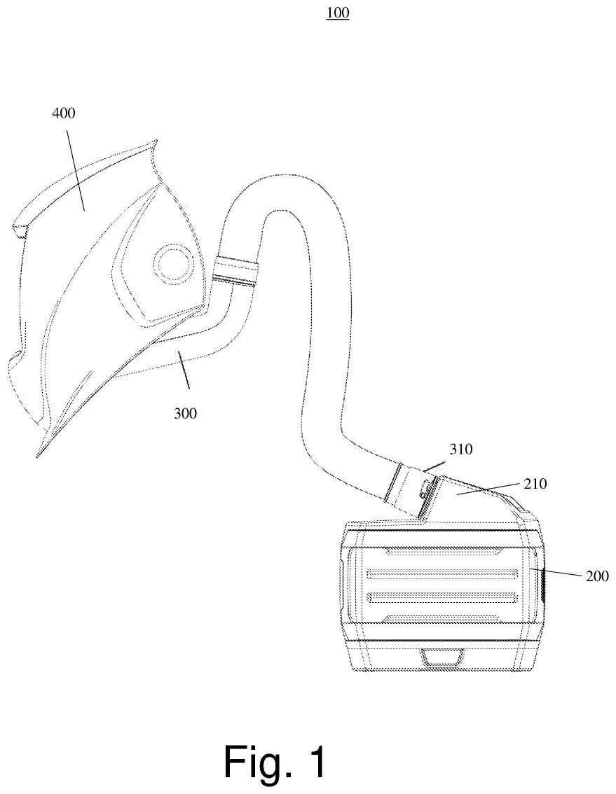

FIG. 1 is a view schematically illustrating an electric breathing apparatus 100 according to one embodiment of the present application. The electric breathing apparatus 100 is configured to include an air filter device 200, a breathing mask 400, and a connecting hose 300 (alternatively, a connecting pipe) connected between the air filter device 200 and the breathing mask 400. The air filter device 200 is for example worn by a user. For instance, the air filter device can be worn onto the waist of the user's body. The breathing mask 400 can be worn on the user's head. For instance, the breathing mask 400 may be a medical epidemic isolation mask, a respirator mask, a welding helmet or the like. Ambient air is driven by an internal electric blower (mentioned below) of the air filter device 200 to be sucked into the air filter device and, after being filtered there, to be supplied by the connecting hose 300 to the breathing mask 400 for inhalation by the user.

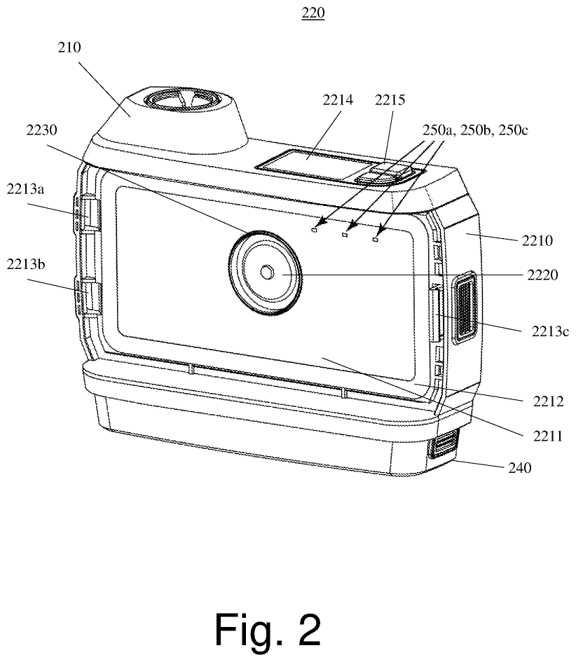

The air filter device 200 has a connector port 210 to which a joint 310 of the connecting hose 300 is releasably connectable. It should be understood by one ordinary person in the art that the shape of the connector port 210 is not limited to that illustrated by FIG. 1; rather, it can be shaped in other forms (like illustrated by FIGS. 2 to 4). Similarly, the joint 310 can take a shape illustrated by FIG. 1 or 3 or 4 or alternatively any other suitable shape as long as the shaped connector port 210 and joint 310 can achieve a releasable connection therebetween as mentioned later.

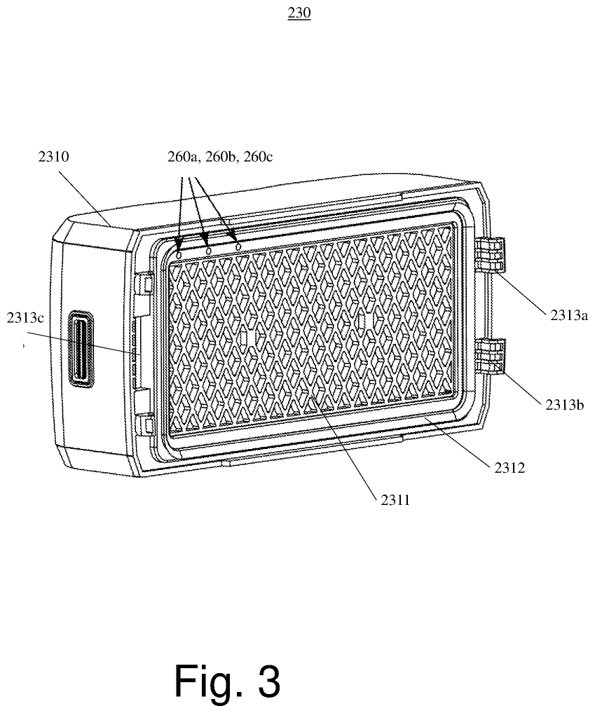

Further as shown by FIGS. 2 and 3, according to one example of the present application, the air filter device 200 is configured to include a blower unit 220 and an air filter unit 230 releasably connectable to the blower unit. The blower unit 220 is configured to include a housing 2210. For instance, the connector port 210 of the air filter device 200 is located in the housing 2210. Defined in the housing 2210 is an internal cavity for accommodating the electric blower 2220 (which is partially visible in FIG. 2) therein. Furthermore, also formed in the housing 2210 is an air inlet 2230. The housing 2210 is configured in such a way that when the electric blower 2220 is powered on to be activated, air can be sucked via the air inlet 2230 into the internal cavity where the electric blower 2220 locates, and then be discharged out via the connector port 210. In order to supply electric power to the electric blower, a rechargeable battery 240 is releasably connected to the housing 2210. The blower unit 220 is configured to include a display screen 2214 on which various parameters can be displayed and a control button 2215 by which a relevant part, such as the blower 2220, of the blower unit 220 can be controlled.

The air inlet 2230 is formed in an interface 2211 of the housing 220. An annual edge 2212 is provided around the interface 2211. For example, the annual edge 2212 can be integrally formed on the housing 2210 or alternatively can be made by an elastic seal material and then be attached on a surface of the housing 2210. Besides, a plurality of snap-fit parts, for example three snap-fit parts 2213a, 2213b, 2213c, are formed on an outer surface of the housing 2210 adjacent to the annular edge 2212 respectively.

The air filter unit 230 is configured to include a casing 2310 which is generally in the form of a square box. It should be understood by the ordinary person in the art that the casing 2310 can be in the form of any other suitable shape such as a flat shape. Further as shown by FIG. 3, internally defined in the casing 2310 of the air filter unit 230 is a cavity for holding a filter media (not shown) therein. Depending on sites where the electric breathing apparatus 100 is to be used, different filter mediums will be held there. A filter mesh side 2311 is formed in the casing 2310. Opposite to the filter mesh side 2311, an air suction side (not shown by FIG. 3) is also formed in the casing 2310. A plurality of orifices are formed in the air suction side such that air can be constrained in such a flowing path only, i.e. air will pass through the air suction side only, be filtered by the filter medium and then be discharged out via the filter mesh side 2311.

An annual edge 2312 is also provided around the filter mesh side 2311. For example, the annular edge 2312 can be integrally formed on the casing 2310 or alternatively can be made of an elastic seal material and then be attached on a surface of the casing 2310. Besides, a plurality of snap-fit parts, for example three snap-fit parts 2313a, 2313b, 2313c, are formed on an outer surface of the casing 2310 adjacent to the annular edge 2312 respectively. The snap-fit parts 2313a, 2313b, 2313c of the air filter unit 230 are paired to the snap-fit parts 2213a, 2213b, 2213c of the blower unit 220 respectively, such that they can be mated with each other and thus the air filter unit 230 can be snapped onto the blower unit 220. When the air filter unit 230 is correctly connected to the blower unit 220 (i.e. the former is installed onto the latter in place), the filter mesh side 2311 of the air filter unit 230 opposes the interface 2211 of the blower unit 220; and the edge 2312 of the air filter unit 230 is in complete contact with the edge 2212 of the blower unit 220 so as to form a seal interface therebetween. In this way, air filtered through the air filter unit 230 can be ensured to be driven into the air inlet 2230 of the blower unit 220 without any contact with the external environment.

However, in case that the air filter unit 230 is not installed onto the blower unit 220 in place, the edge 2312 of the air filter unit 230 and the edge 2212 of the blower unit 220 may not be in complete contact with each other even if the snap-fit parts 2313a, 2313b, 2313c and the snap-fit parts 2213a, 2213b, 2213c have been in engagement with each other respectively to connect the air filter unit 230 with the blower unit 220. In this case, any gap probably existing between the edges 2312 and 2212 may result in that harmful ambient air is sucked into the blower unit 220 and then is inhaled by the user.

Furthermore, as already mentioned, at various work sites, different filter mediums shall be installed into the air filter unit. This means that when the air filter unit is installed with the different filter mediums, the blower of the blower unit is required to operate in different modes, for example at different rates of the blower, at different interval time running cycles or the like. Therefore, in the prior art, this requires that the user has to manually reset the blower, especially its blower's operating mode after different air filter units are replaced. However, this will result in the increased usage complexity of the electric breathing apparatus by the user. Then, if the user forgets to reset the blower unit, there is a risk that air which is not clean enough is sucked there.

In order to solve the above issues, the technical solution of the present application requires that a plurality of proximity switches (or proximity sensors) spaced from each other are arranged between the air filter unit 230 and the blower unit 220, such that only when these proximity switches are all identified to correctly match with counterparts cooperating with them, it is determined that the air filter unit 230 has been installed on the blower unit 220 in place; and depending on the identified and combined manner of the proximity switches, the model or type of the air filter unit 230 can be automatically determined and correspondingly the blower unit 220, especially the respective blower 2220's operating manner can be automatically reset.

In a preferred embodiment of the present application, the proximity switches mentioned above are Hall sensors. Therefore, take the Hall sensors for example to illustratively and non-limitedly explain the present application below. However, it should be understood by the ordinary person in the art that any other suitable devices such as photoelectric proximity switches, eddy current proximity switches or the like can be adopted as the proximity switches or similar devices in the technical solution of the present application.

According to an embodiment of the present application, as shown by FIGS. 2 and 3, a plurality of Hall sensors, for example three Hall sensors 250a, 250b, 250c, are arranged in the housing 2210 of the blower unit 220. These Hall sensors are electrically connected to a central control unit (ECU) by which the blower unit 220 is controllable. For instance, the Hall sensors 250a, 250b, 250c can be arranged in the interface 2211 of the housing 220. In a preferred embodiment, the Hall sensors 250a, 250b, 250c are configured to be arranged in the interface 2211 in such a way that they are invisible from the outside. For example, these Hall sensors are configured to be embedded into the housing 2210 in such a way that they cannot be observed from the outside. The air filter unit 230 is provided with a plurality of alignment positions spaced from each other, at which positions several magnetic counterparts can be selectively disposed as desired. For instance, these alignment positions are in a plane where the filter mesh side 2311 of the air filter unit 230 locates, such that after the air filter unit 230 is installed onto the blower unit 220 in place, these alignment positions can be exactly aligned with the Hall sensors of the blower unit 220 respectively. For instance, there are three alignment positions 260a, 260b, 260c provided in the air filter unit 230.

For illustrative purposes only, FIGS. 2 and 3 schematically show how the Hall sensors 250a, 250b, 250c and the alignment positions 260a, 260b, 260c are arranged. However, it can be understood by the ordinary person in the art that the Hall sensors 250a, 250b, 250c can be alternatively arranged in the blower unit 220 in a more divergent manner at other locations such that the blower unit can be correctly aligned with the air filter unit 230 when it is correctly connected to the air filter unit 230. In the meanwhile, the alignment positions 260a, 260b, 260c of the air filter unit 230 can be correspondingly relocated.

Here, take the three alignment positions 260a, 260b, 260c of the air filter unit 230, at each of which positions a magnetic counterpart is arranged, for example to explain the present application. For instance, each magnetic counterpart may be a magnetic sheet, a magnetic ball or a component made of a permanent magnet material. In a preferred embodiment, each magnetic counterpart is invisibly provided in the casing 2310 of the air filter unit 230. For example, the magnetic counterparts are configured to be embedded in the casing 2310 in such a way that they cannot be observed from the outside. In case that the blower unit 220 is powered on for its activation, the ECU of the blower unit 220 is configured to constantly monitor the statues of the Hall sensors 250a, 250b, and 250c. Therefore, when the air filter unit 230 is installed onto the blower unit 220 in place, the magnetic counterparts located at the alignment positions 260a, 260b, 260c can be first adjacent to and then aligned with the respective Hall sensors 260a, 260b, 260c such that the Hall sensors 250a, 250b, and 250c can generate triggering signals respectively. The ECU of the blower unit 220 is configured such that when it is determined that all of the Hall sensors 250a, 250b, 250c have generated their respective triggering signals, the air filter unit 230 can be deemed to be already installed on the blower unit 220 in place and thus some hint showing such installation can be provided for the user via the display screen 2214, a beeper, a vibrator, or any other suitable prompting device (not shown here); and/or only in case of such determination, an activating key of the blower unit 220 is enabled to be pressed by the user to further operate the blower unit.

It should be understood by the ordinary person in the art that in an alternative embodiment only one magnetic counterpart can be provided on the air filter unit 230 to match with one Hall sensor of the blower unit 220 so as to determine whether the air filter unit 230 is installed onto the blower unit 220 in place. Of course, if two or more magnetic counterparts can be arranged in the air filter unit 230 to match with two or more Hall sensors provided in the blower unit 220, the accuracy of the installation determination can be further enhanced.

Alternatively and/or additionally, how to determine different models/types of air filter units which can be used in the blower unit 220 of the present application will be explained for example by referring to the Hall sensors 250a, 250b, 250c and selective arrangement of a magnetic counterpart or magnetic counterparts at the alignment positions 260a, 260b, 260c of the air filter unit 230.

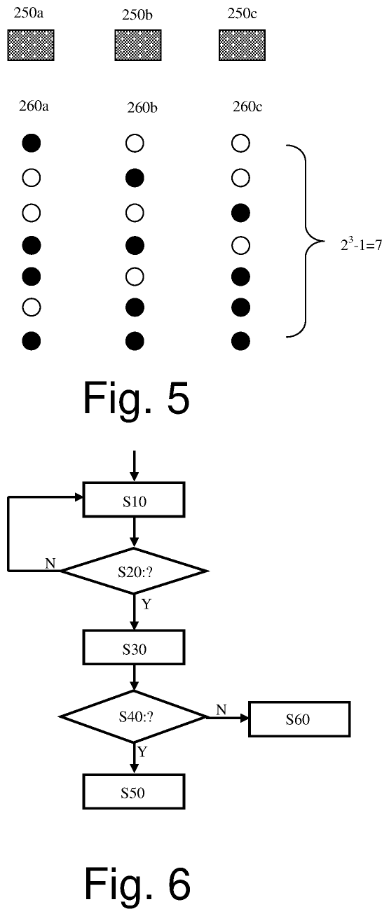

As shown by FIG. 5, it is assumed that the three Hall sensors 250a, 250b, 250c arranged on the blower unit 220 are devoted to recognize the model or type of the air filter unit 230. In the context of the present application, different models or types of air filter units mean that the air filter units have different filter mediums and/or differently arranged filter mediums therein. Although there are three alignment positions 260a, 260b, 260c on the air filter unit 230, it does not mean that each of the three alignment positions has to be allocated with a magnetic counterpart. Therefore, different magnetic counterpart arrangements/layouts caused by the magnetic counterpart(s)'s different combinations can be generated on the air filter unit 230. For example, on the air filter unit 230 as shown by FIG. 5, there are 7 possible layouts (=2³−1) relating to the magnetic counterpart(s). It is assumed that one Hall sensor when detecting one counter magnetic counterpart if arranged will produce a triggering signal of “1”, and the same one Hall sensor when not detecting the counter magnetic counterpart if arranged will produce a triggering signal of “0”. Then, the three Hall sensors 250a, 250b, 250c may produce possible combinations of triggering signals which are “100”, “010”, “001”, “110”, “101”, “011” and “111” respectively. Depending on these possible combinations, a manufacturer of the air filter unit 230 can manufacture different models or types of air filter units correspondingly. For example, for a first model or type of air filter unit, a single magnetic counterpart is arranged at the alignment position 260a only; for a second model or type of air filter unit, two magnetic counterparts are arranged at the alignment positions 260a and 260b respectively only; and for a third model or type of air filter unit, a magnetic counterpart is arranged at each of the three alignment positions 260a, 260b, 260c. Therefore, when the Hall sensors 250a, 250b, 250c have detected the triggering single combinations of “100”, “110”, and “111”, the first, second and third models or types of air filter unit can be respectively recognized.

That is to say, it is assumed that there are N Hall sensors provided in the blower unit 220 and there are N alignment positions in the air filter unit, wherein the N is an integer which is equal to or greater than 2, and 1˜N magnetic counterparts can be selectively arranged at a designated one or some designated ones or all of the N alignment positions, so as to recognize the concrete model or type of the air filter unit. Therefore, for the air filter unit 230, there will be 2N−1 possible layouts of the magnetic counterpart(s) so as to distinguish the different models or types of possible air filter units which will be used as a replacement one of the air filter unit 230.

As shown by FIG. 6, a control operation method according to one example of the present application will be explained below. It should be understood by the ordinary person in the art that this method example can be stored as executable codes in a memory of the ECU. Then, these executable codes can be read and executed by the ECU to control the operation(s) of one or more relevant components.

According to the present application, a plurality of Hall sensors are provided in the blower unit 220 and a plurality of alignment positions are allocated in the air filter unit 230, which alignment positions are configured to determine whether the air filter unit 230 is installed on the blower unit 220 in place. The plurality of Hall sensors can be divided into a first subset of Hall sensors by which it can be determined whether the air filter unit 230 is installed onto the blower unit 220 in place; and into a second subset of Hall sensors by which the model or type of the air filter unit 230 can be recognized. The first subset of Hall sensors is configured to include one or more Hall sensors. The second subset of Hall sensors is configured to include N Hall sensors, wherein the N is an integer which is equal to or greater than 2. Therefore, the plurality of alignment positions of the air filter unit 230 can be correspondingly divided into a first subset of alignment positions matching with the first subset of Hall sensors, and a second subset of alignment positions matching with the second subset of Hall sensors.

In the air filter unit 230, one magnetic counterpart is arranged at each alignment position of the first subset of alignment positions, and the second subset of alignment positions are configured to be arranged selectively with one magnetic counterpart or a desired number of magnetic counterparts depending on the model or type of the air filter unit 230 in a manner as similarly shown by FIG. 5. Furthermore, an operating mode library, which is configured to include operating modes matching with different models or types of air filter units (i.e. the possible layouts of the relevant magnetic counterparts at the second subset of alignment positions of the air filter unit, and corresponding to the triggering signal combinations of FIG. 5), can be pre-stored in the memory of the blower unit 220.

At a step S10, the air filter unit 230 is installed onto the blower unit 220. At a step S20, it is determined whether each Hall sensor of the first subset of Hall sensors has detected a magnetic counterpart. If no magnetic counterpart or not all magnetic counterparts are detected, the air filter unit 230 will be deemed not to be installed on the blower unit 220 in place and then an alarm message could be sent to the user via the display screen 2214, the beeper, the vibrator, or any other suitable prompting device (not shown here), so as to inform the user that the process need return to the step S10 such that the air filter unit 230 shall be reinstalled onto the blower unit 220. If at the step S20 all of the first Hall sensors have detected their respective magnetic counterparts, the process returns to a step S30. At the step S30, it is determined what the layout of the respective magnetic counterparts detected by the second subset of the Hall sensors will be (i.e. what the triggering signal combination is). At a step S40, a pre-stored operating mode library will be queried to identify whether there exists a layout manner corresponding to the layout of the respective magnetic counterparts detected by the second subset of the Hall sensors. If the query result is YES, the process goes to a step S50. If the query result is NO, the process goes to a step S60. At the step S50, the blower unit 220 is configured such that its operating mode is automatically reset depending on the identified model/type of the air filter unit, and the user is allowed to control the operation of the blower unit 220. At the step S60, some alert information could be provided to the user via the display screen 2214, the prompting device (not shown here) such as the beeper, the vibrator or the like, such that the user can know that the model/type of the air filter unit is not identified, the air filter unit shall be replaced by a new one or the operation of the blower unit 220 is forbidden to be controllable.

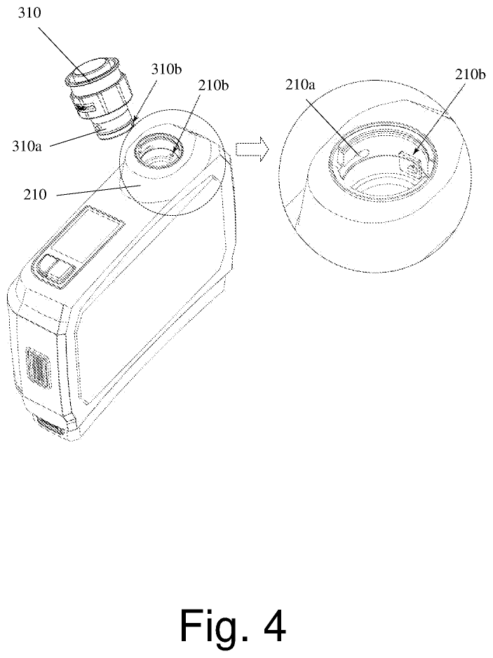

Similarly, the proximity switch configuration/design, for example the configuration of the Hall sensor and the magnetic counterpart, could be adopted between the joint 310 of the connecting hose 300 and the c of the air filter device 200. As shown by FIG. 4, an engagement feature 210a is provided in the connector port 210 and a mating feature 310a for engagement with the engagement feature 210a is provided in the joint 310. In the meanwhile, one or more Hall sensors 210b spaced from each other are provided at or adjacent to the engagement feature 210a in the connector port 210. Corresponding to the Hall sensor(s), one or more magnetic counterparts (for example, in a way that the magnetic counterpart or the magnetic counterparts are invisible from the outside similarly as shown by FIG. 2) are provided at or adjacent to the mating feature 310a in the joint 310. The magnetic counterpart(s) could be configured and/or arranged in such a way that when the joint 310 is installed onto the connector port 210 in place, the magnetic counterpart (s) is/are aligned with the respective Hall sensor(s) 210 of the connector port 210. In this way, it can be ensured that the Hall sensor(s) 210 can generate a corresponding triggering signal. Similar to what is shown by FIG. 6, depending on detection of the triggering signal generated by the Hall sensor(s) 210 with respect to the magnetic counterpart(s), it is determined whether the joint 310 has been installed onto the connector port 210 in place.

Therefore, using the inventive technical measures, it can be detected whether the air filter unit has been installed onto the blower unit in place and whether the connecting hose 300 is installed onto the air filter unit in place. Besides, the model/type of the air filter unit can be automatically identified after the installation, such that the operating mode of the blower unit can be reset. Therefore, the electric breathing apparatus according to the present application can be operated more reliably and conveniently.

Although some specific embodiments and/or examples of the present application have been described here, it should be understood that they are given for illustrative purposes only and cannot be deemed to constrain the scope of the present application in any way. Furthermore, it is understood by the ordinary person in the art that the embodiments and/or examples mentioned in the description can be combined with each other as desired. Without departing from the spirit and scope of the present application, various modifications, alternations and/or replacements can be thought out.

1-13. (canceled)

14. An air filter device for an electric breathing apparatus, comprising:
a blower unit configured to include a housing in which an electric blower is disposed; and
an air filter unit configured to releasably connect to the blower unit, the air filter unit including a casing that includes a filter mesh side configured to face towards the blower unit when the blower unit is connected to the air filter unit,
wherein the housing of the blower unit includes:
an interface configured to face towards the air filter unit when the blower unit is connected to the air filter unit, and
a first subset of Hall sensors in the interface, the first subset of Hall sensors comprises N Hall sensors spaced from each other, wherein N is an integer which is equal to or greater than 2,
wherein the casing of the air filter unit also includes N alignment positions configured to align with the N Hall sensors respectively when the air filter unit is connected to the housing of the blower unit, and
wherein the casing of the air filter unit also includes 1˜N magnetic counterparts selectively disposed at the N alignment positions, and the 1˜N magnetic counterparts are configured to be arranged at the N alignment positions in a manner matching with an operating mode of the blower unit with respect to the air filter unit.

15. The air filter device as recited in claim 14, wherein the 1˜N magnetic counterparts are configured to be selectively arranged at the N alignment positions in 2N−1 manners.

16. The air filter device as recited in claim 14, wherein:
the N Hall sensors are disposed in the housing of the blower unit in such a way that the N Hall sensors are invisible from an outside of the housing of the blower unit, and
the 1˜N magnetic counterparts are disposed in the casing of the air filter unit in such a way that the 1˜N magnetic counterparts are invisible from an outside of the casing of the air filter unit.

17. The air filter device as recited in claim 15, wherein:
the N Hall sensors are disposed in the housing of the blower unit in such a way that the N Hall sensors are invisible from an outside of the housing of the blower unit, and
the 1˜N magnetic counterparts are disposed in the casing of the air filter unit in such a way that the 1˜N magnetic counterparts are invisible from an outside of the casing of the air filter unit.

18. The air filter device as recited in claim 14, wherein:
the housing of the blower unit also includes a second subset of Hall sensors in the interface, wherein the second subset of Hall sensors includes at least one Hall sensor;
the casing of the air filter unit also includes at least one additional alignment position in the filter mesh side, the at least one additional alignment position is configured to align with the second subset of Hall sensors respectively when the air filter unit is installed in place onto the blower unit;
one additional magnetic counterpart is disposed at each of the at least one additional alignment position.

19. The air filter device as recited in claim 15, wherein the housing of the blower unit also includes a second subset of Hall sensors in the interface, wherein the second subset of Hall sensors includes at least one Hall sensor;
the casing of the air filter unit also includes at least one additional alignment position in the filter mesh side, the at least one additional alignment position is configured to align with the second subset of Hall sensors respectively when the air filter unit is installed in place onto the blower unit;
one additional magnetic counterpart is disposed at each of the at least one additional alignment position.

20. The air filter unit as recited in claim 18, wherein the housing of the blower unit is configured to include a first annular edge formed around the interface, the casing of the air filter unit is configured to include a second annular edge formed around the filter mesh side, the first annular edge and the second annular edge are configured to be in complete contact with each other when the air filter unit is installed in place onto the blower unit.

21. The air filter unit as recited in claim 19, wherein the housing of the blower unit is configured to include a first annular edge formed around the interface, the casing of the air filter unit is configured to include a second annular edge formed around the filter mesh side, the first annular edge and the second annular edge are configured to be in complete contact with each other when the air filter unit is installed in place onto the blower unit.

22. The air filter device as recited in claim 20, wherein the first subset of or the second subset of Hall sensors is located in a region surrounded by the first annular edge, and
the N alignment positions or the at least one additional alignment position is located in a region surrounded by the second annular edge.

23. The air filter device as recited in claim 21, wherein the first subset of or the second subset of Hall sensors is located in a region surrounded by the first annular edge, and
the N alignment positions or the at least one additional alignment position is located in a region surrounded by the second annular edge.

24. The air filter device as recited in claim 20, further comprising a connector port configured to be releasably connectable to a joint of a connecting hose of the electric breathing apparatus,
wherein the connector port is provided with a third subset of Hall sensors comprising at least one Hall sensor,
wherein the joint is configured to include at least one additional alignment position configured to be aligned with the third subset of Hall sensors respectively when the joint is installed in place to the connector port, and
wherein one additional magnetic counterpart is provided respectively at each of the at least one additional alignment position of the joint.

25. The air filter device as recited in claim 21, further comprising: a connector port configured to be releasably connectable to a joint of a connecting hose of the electric breathing apparatus,
wherein the connector port is provided with a third subset of Hall sensors comprising at least one Hall sensor,
wherein the joint is configured to include at least one additional alignment position configured to be aligned with the third subset of Hall sensors respectively when the joint is installed in place to the connector port, and
wherein one additional magnetic counterpart is provided respectively at each of the at least one additional alignment position of the joint.

26. The air filter device as recited in claim 24, wherein at least one magnetic counterpart comprises a magnetic ball or sheet made of a permanent magnet material.

27. The air filter device as recited in claim 25, wherein at least one magnetic counterpart comprises a magnetic ball or sheet made of a permanent magnet material.

28. An air filter device for an electric breathing apparatus, comprising:
a blower unit configured to include a housing in which an electric blower is disposed;
an air filter unit configured to be releasably connectable to the blower unit, the housing of the blower unit including an interface configured to face towards the air filter unit when the blower unit is connected to the air filter unit, the air filter unit including a casing, the casing including a filter mesh side configured to face towards the blower unit when the blower unit is connected to the air filter unit,
wherein the housing of the blower unit also includes a first subset of proximity switches in the interface, the first subset of proximity switches comprises N proximity switches spaced from each other, wherein N is an integer which is equal to or greater than 2;
wherein the casing of the air filter unit also includes N alignment positions configured to align with the N proximity switches respectively when the air filter unit is connected to the housing of the blower unit; and
wherein the air filter unit includes 1˜N counterparts selectively disposed at the N alignment positions, and the 1˜N counterparts are configured to be arranged at the N alignment positions in a manner matching with an operating mode of the blower unit with respect to the air filter unit.

29. An electric breathing apparatus comprising:
an air filter device comprising:
a blower unit configured to include a housing in which an electric blower is disposed; and
an air filter unit configured to releasably connect to the blower unit, the air filter unit including a casing that includes a filter mesh side configured to face towards the blower unit when the blower unit is connected to the air filter unit,
a breathing mask; and
a connecting hose configured to be connected between the breathing mask and the air filter device,
wherein the housing of the blower unit includes:
an interface configured to face towards the air filter unit when the blower unit is connected to the air filter unit, and
a first subset of Hall sensors in the interface, the first subset of Hall sensors comprises N Hall sensors spaced from each other, wherein N is an integer which is equal to or greater than 2,
wherein the casing of the air filter unit also includes N alignment positions configured to align with the N Hall sensors respectively when the air filter unit is connected to the housing of the blower unit, and
wherein the casing of the air filter unit also includes 1˜N magnetic counterparts selectively disposed at the N alignment positions, and the 1˜N magnetic counterparts are configured to be arranged at the N alignment positions in a manner matching with an operating mode of the blower unit with respect to the air filter unit.

30. The electric breathing apparatus as recited in claim 29, wherein:
a number of 1˜N magnetic counterparts that are presented at the N alignment positions or a layout of the 1˜N magnetic counterparts arranged at the N alignment positions is detected to compare the detected result with pre-stored magnetic counterpart cases or layouts to determine a model or a type of the air filter unit, and
an operating mode of the blower unit is reset depending on the determined model or the determined type of the air filter unit.

31. The electric breathing apparatus as recited in claim 30, wherein after the air filter unit is connected to the blower unit and before the model or the type of the air filter unit is determined, a second subset of Hall sensors of the blower unit is monitored to determine whether or the second subset of Hall sensors is aligned with the additional magnetic counterpart at the additional alignment position of the air filter unit so as to determine whether the air filter unit has been installed in place onto the blower unit.

32. The electric breathing apparatus as recited in claim 31, wherein an alarm is sent out or the blower unit is deactivated if the air filter unit is not installed in place onto the blower unit.
